(19) United States
(12) Patent Application Publication
(10) Pub. No.: US 2014/0208608 A1
(43) Pub. Date: Jul. 31, 2014

(54) Backplate

(71) Applicant: Michael E. Robert, Farmington Hills, MI (US)

(72) Inventor: Michael E. Robert, Farmington Hills, MI (US)

(21) Appl. No.: 13/751,491

(22) Filed: Jan. 28, 2013

(51) Int. Cl. F26B 25/08

(52) U.S. Cl. CPC F26B 25/08
USPC 34/523

(57) ABSTRACT

A dryer with an air outlet disposed above the motor assembly and having a backplate that mounts to a supporting structure. The backplate includes an integral air channel between the blower assembly and the air outlet.

### BACKGROUND OF THE INVENTION

1. Field of the Invention

The present invention is generally directed to a dryer with an air outlet disposed above the motor assembly and having a backplate that mounts to a supporting structure and also includes an integral air channel between the blower assembly and the air outlet.

2. Description of the Prior Art

Wall or surface mounted dryers have been used for many years in washrooms for drying a person's hands. Originally, most of these dryers used low velocity air, causing the drying process of the hands to be fairly slow. To speed up the drying process, many manufacturers created high-speed or high velocity hand dryers. As the velocity of the air impacting the hands increased, the water or moisture on the hands is increasingly sprayed off in a fine mist to the surrounding surfaces, particularly depending on how the user positions their hands. In certain high usage situations, such as airports and sporting facilities, the water and moisture may visibly accumulate on the walls, floor, and surrounding surfaces. To protect the surrounding surfaces, manufacturers have tried a number of options, none of them completely successful.

Some manufacturers developed hand dryers having a trough into which the user inserted their hands to minimize the ability of the moisture to be blown off the hands to the surrounding surfaces. However, as these trough style dryers trapped moisture in a small area, the moisture may accumulate and therefore, they require substantially more cleaning than traditional hand dryers. In trough-style hand dryers, the motor assembly and air nozzles are generally located below the hands, with the hands being inserted toward the air nozzles. In addition, most trough-style dryers are very difficult for disabled people to easily access from a wheelchair.

Currently, in the United States, the ADA requires that protruding objects with leading edges of more than 27 inches and not more than 80 inches above the finished floor or ground shall not protrude more than 4 inches maximum horizontally into a circulation pathway, such as a hallway or passageway. Many facilities also have substantial design limitations where hand dryers may actually be installed, including when considering the flow of people entering and exiting a washroom. Currently, all traditional hand dryers mounted to walls must be mounted much higher than 27 inches from the ground to be functional, leaving only two options to meet ADA requirements. The first option is to recess the dryer into the wall so that it protrudes less than 4 inches while the second option is to use a low-profile dryer having a complete thickness when mounted of less than 4 inches. Low-profile hand dryers having a thickness of less than 4 inches are expensive when compared to traditional hand dryers and are not capable of providing high-speed air drying. Furthermore, low-profile hand dryers are difficult to use, as a user typically needs to place their hands extremely close to the supporting surfaces to insert them into the air stream. Given the positioning of the hands, the user typically contacts the wall at least once during the drying process. Hand dryers recessed into the wall are also problematic as most facility managers avoid any major modifications to the walls of a washroom. Currently, there are no hand dryers that provide compact, low-profile, ADA compliant, surface mounted hand dryers.

### SUMMARY OF THE INVENTION

The present invention is generally directed to a dryer with a contoured backplate that allows for a low-profile dryer having an outer contoured surface with a cavity to place the hands between the blower assembly and the air outlet assembly. More specifically, the present invention provides a contoured backplate for a dryer assembly which allows air to be channeled through the backplate form the blower assembly to the air outlet and thereby creating a compliant, low-profile dryer that without wasted space, may be usably mounted within 27 inches of the floor.

The present invention is more specifically directed to a dryer assembly for mounting to a support structure having an electrical service, wherein the dryer assembly includes a backplate configured to mount to the support structure and defining an air channel. The backplate may be viewed as having an upper portion, a middle portion and a lower portion and the air channel extends from the lower portion through the middle portion and to the upper portion. The lower portion may define a blower inlet in fluid communication with the air channel and the upper portion may define an air outlet in fluid communication with the air channel.

The air channel includes a longitudinal portion and a lateral portion extending therefrom. The lateral portion is located in the upper portion and defines the air outlet, and the blower inlet is defined by the longitudinal portion.

The backplate further includes an outer perimeter having a first longitudinal side approximately aligned with a second longitudinal side and first and second lateral sides extending between the longitudinal sides. The longitudinal sides are greater in length than the lateral sides and the air channel includes a longitudinal portion aligned with the longitudinal sides. The lateral sides each have a length and wherein the longitudinal portion is located within 25% of the length of the lateral side from the longitudinal side, although if the longitudinal side bows outwardly, it may be greater, or inwardly, it may be less.

The air channel cooperatively includes a first chamber in the lower portion, a second chamber in the upper portion and an air passageway extending there between in the middle portion. The second chamber has a volume that is greater than the volume of the first chamber. In addition, the air passage may have a lateral cross sectional area less than the lateral cross sectional areas of each of the first chamber and the second chambers. As the air is fluidly channeled through the air channel from the blower inlet to the air outlet, the configuration of the air channel allows an increase velocity of the air as it moves from the first chamber to the air passage and decrease velocity of the air as it moves from the air passage to the second chamber. More specifically, the air channel is configured to ensure that during operation the air inlet chamber has a higher velocity of air than the air outlet chamber under a constant supply of air through the blower inlet.

The air channel includes a first chamber having walls defining the blower inlet and the walls are configured to sealing receive a gasket having a laterally extending opening in fluid communication with the first chamber. The gasket is also configured to sealingly engage a blower assembly.

The backplate includes a first surface and a second surface bounded by an outer perimeter. An outer lip extends on the second surface away from the first surface, and the air channel protrudes from the first surface. The second surface defines a first chamber, a second chamber and an air passage of the air channel and wherein the blower inlet and the air outlet each form a passage between the first and second surfaces. The outer lip includes an outer edge having a substantially planar surface configured to mount against the support structure.

The outer lip may include a number of interruptions, such as at least one attachment feature, and the at least one electrical passage. The dryer may also include an outer cover configured to engage the outer lip for a substantial portion of the outer perimeter. The outer cover is more specifically configured to sealingly engage the backplate to ensure that air passing through the blower assembly first passes through the optional filter, if the dryer is equipped with a filter.

The backplate may further include a plurality of attachment locators configured to allow attachment of the backplate to the support structure. The attachment locators generally include a raised surface on the second surface and wherein the raised surface is in substantially planar alignment with the outer edge. The second surface may also include at least one recessed portion relative to the outer edge. The recessed portions are at least a 5 mm recessed, preferably at least 10 mm recessed and more preferably at least 12 mm recessed relative to the outer edge, however it is expected that the bulk of the backplate will be within 25 mm of height relative to the outer edge. The recessed portions may include portions of the second surface proximate to an electrical box on the first surface. In addition, the recessed portions of the second surface form a wall cavity when mounted on the supporting surface and allow power to be routed from the electrical service to the electrical box without drilling holes between the first and second sides other than within the area defined by the first surface within the walls of the electrical box.

The present invention may further include a backplate wherein an outer lip extends on the second surface away from the first surface and wherein the second surface defines an electrical passage having a concave surface extending from the outer lip to an area proximate to an electrical box located on the first surface. The electrical box defines a hole between the first surface and the second surface.

The air outlet is defined by edges and wherein the edges are configured to sealingly receive an air nozzle.

The backplate may include a first large opening forming at least 10% of the area of the backplate in the middle portion, and a second large opening forming at least 5% the area of the backplate in the lower portion.

The present invention may be further directed to a dryer assembly for mounting to a support structure having an electrical service, the dryer assembly including a backplate configured to mount to the support structure, wherein the backplate has a first surface and an opposing second surface configured to face the support structure. The backplate defines a blower inlet extending between the first and second surfaces and an air outlet extending between the first and second surface, and an air channel defined by the backplate extends between the blower inlet and the air outlet. A blower assembly is in fluid communication with the air channel.

The dryer assembly further includes a cover plate and the air channel is a cavity defined by the second surface of the backplate. The cover plate seals the cavity from the second surface. The air channel includes an air inlet chamber proximate to the blower inlet and an air outlet chamber proximate to the air outlet and an air passageway extending between the air inlet chamber and the air outlet chamber and wherein the air passageway has a smaller lateral cross sectional area than the lateral cross sectional area of the air inlet chamber and the air outlet chamber.

The backplate includes an integral electric box having walls and a conduit passage extending between the electric box and an edge of the backplate. The backplate further includes attachment features and is bounded by an outer perimeter and wherein an outer lip extends on the second surface away from the first surface, and wherein the air channel protrudes from the first surface and wherein the outer lip includes an outer edge having a substantially planar surface configured to mount against the support structure. The attachment features include a surface in substantial planar alignment with the planar surface. The backplate may further include a contoured recess on the first surface proximate to the blower assembly.

The present invention further is directed to a dryer assembly for mounting to a support structure having an electrical service, the dryer assembly including, a backplate configured to mount to the support structure, the backplate having an outer perimeter bounding a first surface and an opposing second surface and wherein the second surface is configured to face the support structure and wherein the backplate defines a blower inlet extending between the first and second surfaces and an air outlet extending between the first and second surface; an air channel defined by the backplate and extending between the blower inlet and the air outlet; a blower assembly in fluid communication with the air channel; and an electrical box integrally formed on the backplate and an electrical passage formed on the backplate extending between the electrical box and the outer perimeter. The second surface is configured to be for its majority spaced at least 10 mm from the support structure.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a front right perspective view of a dryer having a splash guard including an integrated blower assembly;

FIG. 2 is an exploded perspective view of the dryer in FIG. 1;

FIG. 3 is a rear perspective view of the backplate;

FIG. 4 is a front elevational view of the backplate;

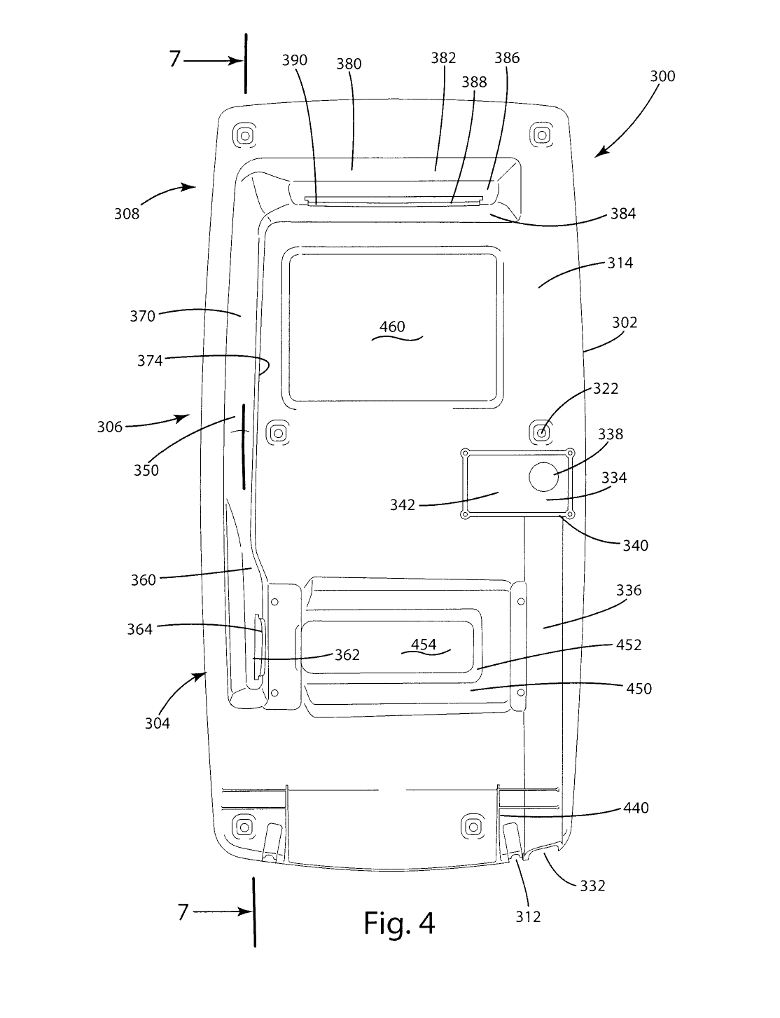

FIG. 5 is a right elevational view of the backplate;

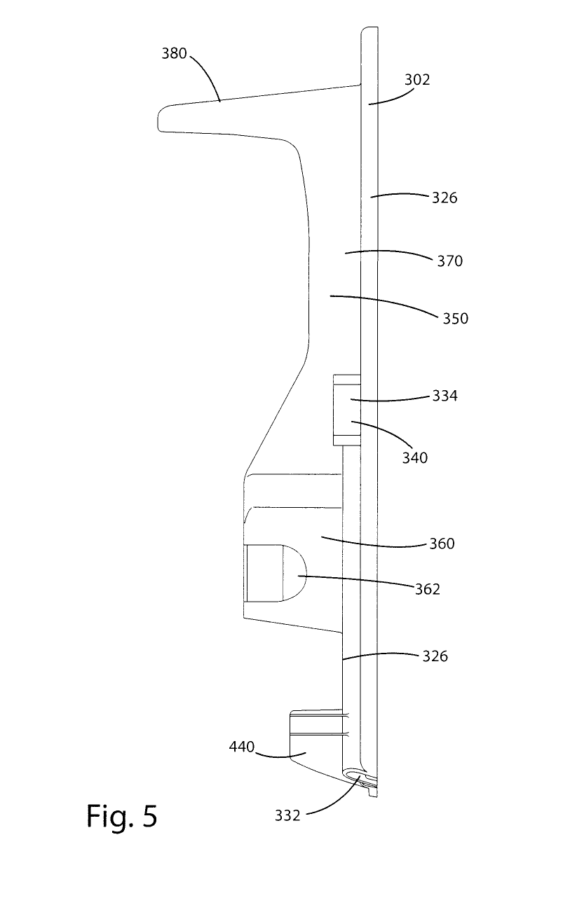

FIG. 6 is a left elevational view of the backplate;

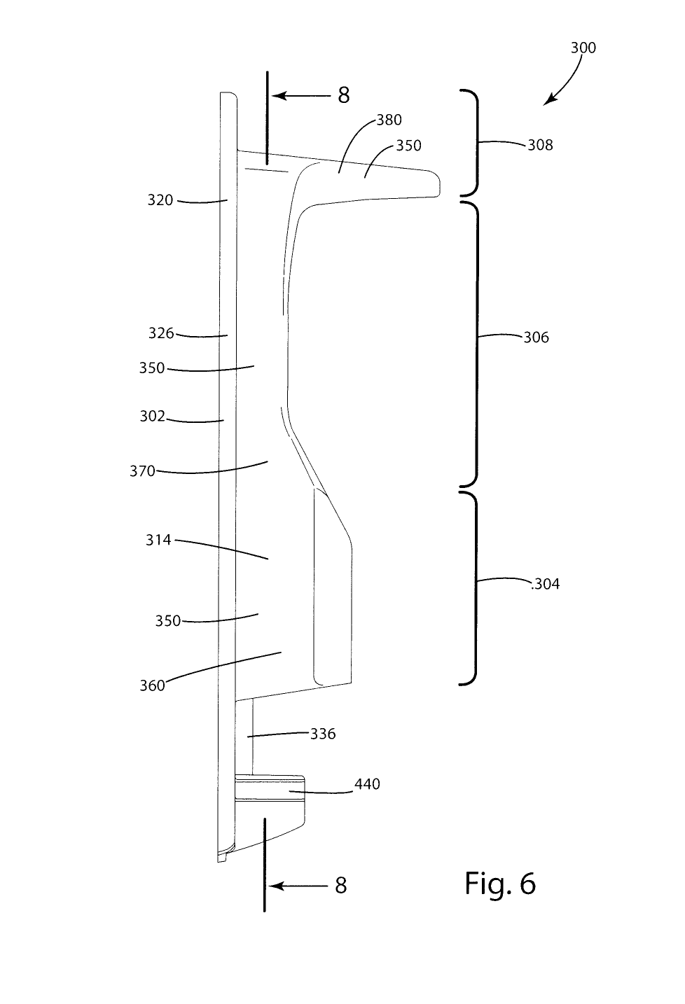

FIG. 7 is a partial cross-sectional view of the backplate along lines 7-7 in FIG. 4;

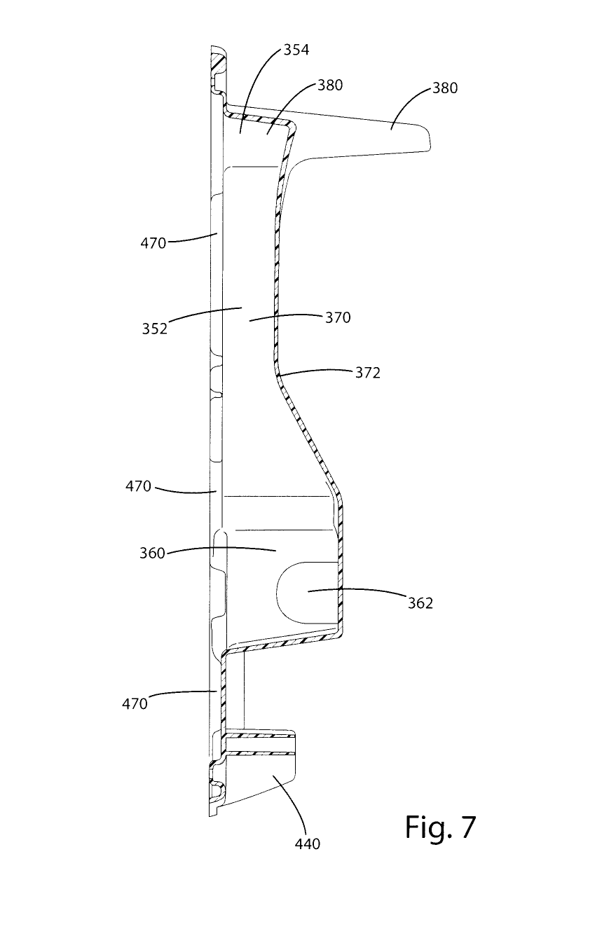

FIG. 8 is a partial cross-sectional view of the backplate along lines 8-8 in FIG. 6; and

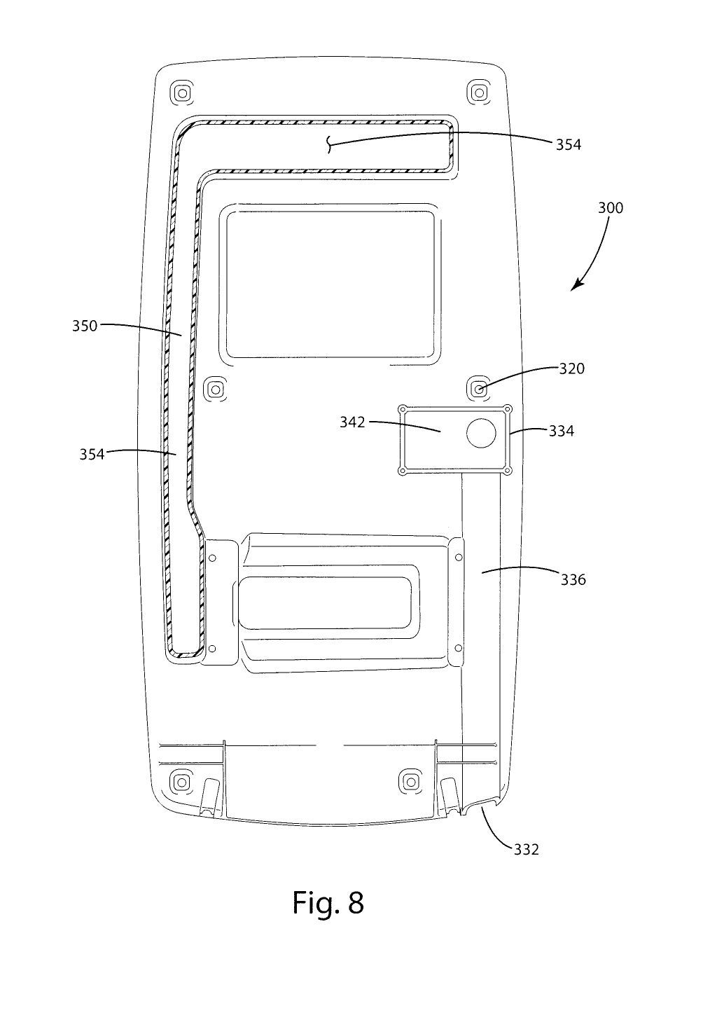

FIG. 9 is a bottom plan view of the backplate.

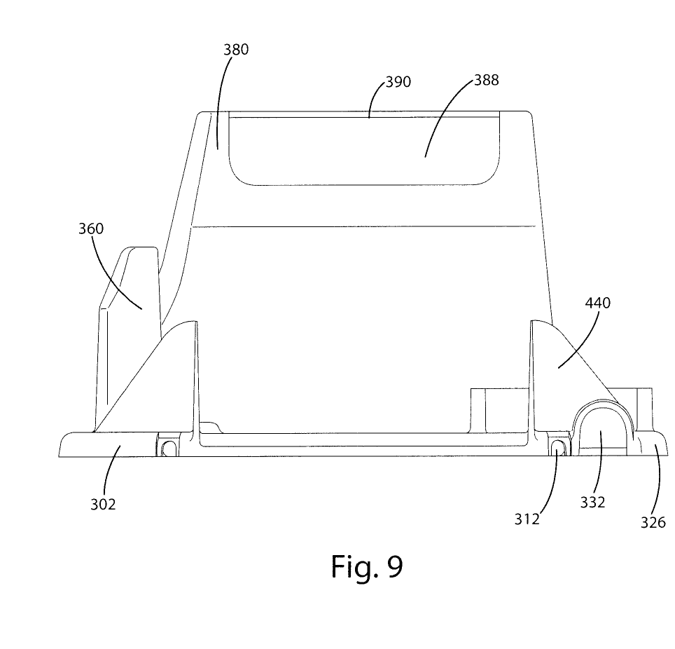

### DETAILED DESCRIPTION OF THE ENABLING EMBODIMENTS

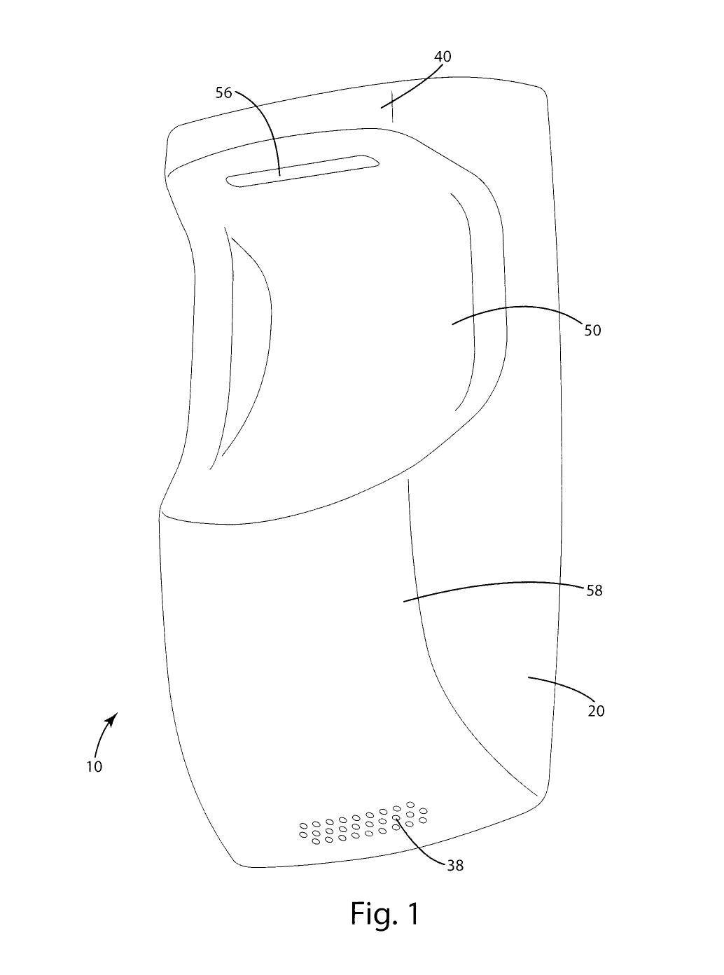

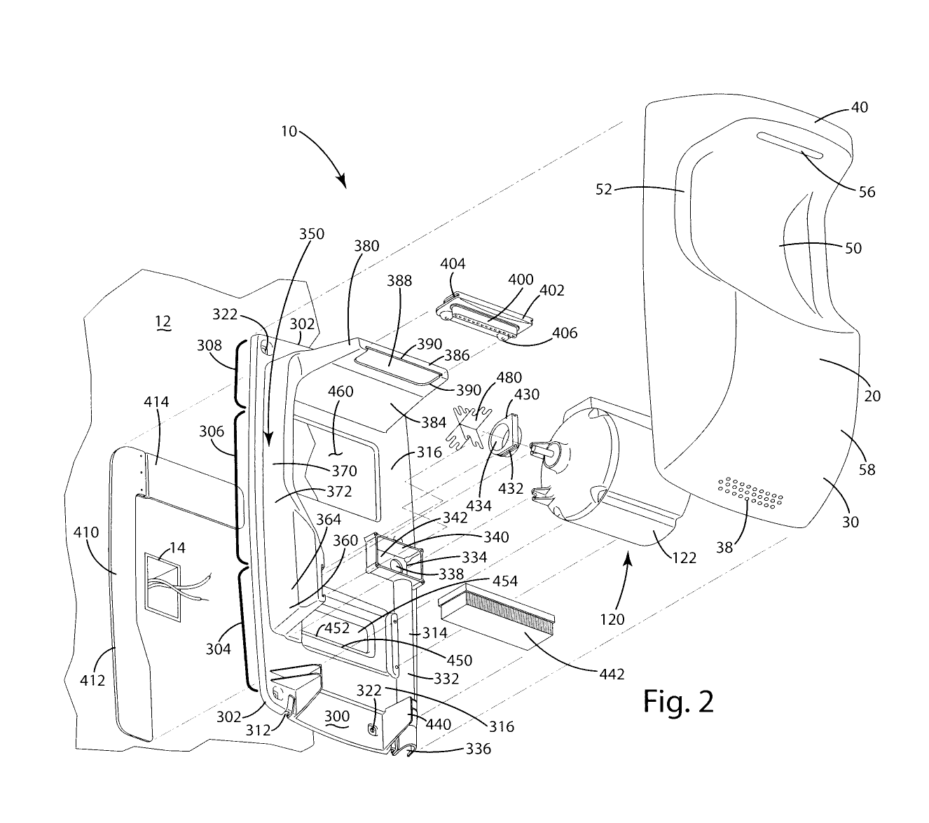

The present invention is generally directed to dryers 10 configured to be mounted on a supporting structure 12 such as a wall. These dryers or dryer assemblies 10 are typically mounted in washrooms, locker rooms and the like. The dryer assemblies 10 generally include an outer shell 20, a blower assembly 120 set within the outer shell and the backplate 30 for mounting the dryer assembly 10 on the supporting structure 12. The outer shell 20 as illustrated in FIG. 1 generally includes a contoured outer surface 30 having an air inlet 38 and an air outlet 56. The blower assembly 120 in the present invention draws in air through the air inlet 38, passes it through the backplate 300 to the air outlet 56. In the exemplary dryer assembly 10 illustrated in FIGS. 1 and 2, the user would place their hands under the air outlet 56 proximate to the evaporation surface 60, which forms an indentation on the contoured outer surface 30. It should be recognized that the outer shell 20 may be formed in a variety of sizes, shapes, styles, and configurations, however, the dryer assembly 10 of the present invention is generally configured to have the blower assembly 120 located on the opposing side of the air outlet 56 relative to the area where the user would place their hands for drying, such as the illustrated evaporation surface 60. Typically, traditional dryers would have a blower assembly configured such that the air outlet is directly proximate and in line with the blower assembly such that the whole dryer unit is located on one side of the hands such as above or below the hands. In contrast, the present invention through locating the blower assembly 120 and air outlet 56 on opposing sides of the operator's hands, allows for a uniquely shaped, efficient, low-profile, and ADA compliant hand dryer for location in circulation pathways. The configuration of the outer shell 20, blower assembly 120, backplate 300, and air outlet 56 is more specifically illustrated in FIG. 2.

The dryer 10 as illustrated in FIG. 1 generally can be divided into three major portions, with reference to the outer shell 20. The upper portion40 generally includes an air outlet 56 extending outward from the supporting surface 12. The adjacent middle portion 50 is located on the contoured outer surface 30, where the surface contours inward, creating an area for the user to place their hands under the air outlet 56. The lower portion 58 generally includes an outward bulge from the supporting surface 12, to allow sufficient room for the blower assembly 120 in the cavity created by the outer shell 20, as illustrated in FIG. 2.

The present invention uses a unique backplate 300 that allows a contoured one piece member to channel air from a blower assembly 120 to air outlet 56 with minimal assembly and space-saving configuration. More specifically, it is very difficult to provide a dryer 10 where the blower assembly 120 is located on the opposite side of the air outlet 56 of where the user places their hands for drying, without using expensive, hard to assemble tubing, while maintaining sufficient air flow between the blower assembly 120 and the air outlet 56. As the high-speed air passing through the tubing has fluid characteristics, the tubing itself creates design limitations on how much and how fast the air can flow through, while also minimizing the power requirements of the blower assembly 120. For a dryer 10, as illustrated in FIGS. 1 and 2, having an outer contoured surface 30 as illustrated, it is almost impossible to channel air from the blower assembly 120 to the air outlet 56 with the use of tubing, as the outer shell 20 would substantially minimize the cross sectional area of any such tubing. More specifically, it would not only be difficult to assemble given the minimal space, particularly in the middle portion 50, but any type of tubing or separate channels routing the air would be susceptible to reduced air output, particularly with high-speed air dryers.

The novel backplate 300 of the present invention allows for easy assembly and improved fluid transfer of the air between the blower assembly 120 and air outlets 56, 388. In addition, the backplate 300 is also specifically configured to allow for easy replacement of existing dryers by having areas that sit proud of the supporting structure 12, when the dryer assembly 10 is mounted on the supporting structure 12, thereby allowing easy routing of power from an electrical service 14 to an integral electrical box 334 on the backplate 300. The integrally formed air channel 350 is also specifically configured to induce velocity changes in the fluid movement of the air through the air channel and thereby reduce the noise emitted by an operational dryer 10. The air channel 350 may be divided into three distinct areas, specifically an air entrance chamber 360, an air passageway 370 and an air outlet chamber 380, each having different volumes and cross sectional areas to provide improved air flow and reduced noise. One current issue with high-speed dryers is that the noise, particularly when multiple dryers operate in a washroom having hard surfaces, the combined noise can be extremely loud. The configuration of the backplate 300 and specifically the air channel 350 on the backplate 300 all work to reduce any noise.

The backplate 300 is expected to be formed out of a composite material. For example, the backplate may be injection molded with all of the illustrated features directly formed on the backplate 300 for easy assembly. The backplate 300 may be formed out of a semi-crystalline polybutylene terephthalate material, which provides the desired structural rigidity, is heat resistive, and includes sound absorbing properties. More specifically, the backplate 300 is preferably formed out of a heat resistive material having acoustic impedance. Of course, the backplate 300 may be formed from other materials, such as Acrylonitrile butadiene styrene or polycarbonate.

The backplate 300 generally includes an outer perimeter 302 having longitudinal sides and lateral sides extending between the longitudinal sides. The longitudinal sides are illustrated as having an arcuate shape and being a mirror image of each other, however they may have any size, shape, or configuration.

The backplate 300 may also be generally divided for reference into a lower portion 304, a middle portion 306 and an upper portion 308, similar to the lower portion 58, middle portion 50, upper portion 40 over the overall dryer 10 and outer shell 20. The lower portion 304 is generally where the blower assembly 120 is located and coupled to the backplate 300, as well as the air entrance chamber 360. The middle portion 306 is approximately located where the user, proximate to the outer shell 20, would place their hands. The backplate further includes an upper portion 308 which includes the air outlet opening 388, which would be aligned with the air outlet 56 on the outer shell 20.

The lower portion 304 of the backplate 300 is primarily configured to receive the blower assembly 120 as well as include the air entrance chamber 360 having a blower inlet 362. Of course, the lower portion 304 includes a number of additional unique features that improve assembly of the dryer 10 as well mounting of the dryer assembly 10 to a supporting structure 12. Starting at the lower edge of the outer perimeter 302, the lower portion 304 includes at least one lower attachment mechanism 312 to allow for easy attachment of the outer shell 20 to the backplate 300 once the backplate 300 is mounted to the support structure 12 using the attachment locaters 322. Furthermore, the lower portion includes an electrical passage entrance 332 and at least a portion of a conduit passage 336 extending to the electrical box 334. While the illustrated outer shell 20 does not include a conduit entrance, it may be configured to be easily cut, including markings for cutting, or even be molded such that the installer could easily snap a portion out of the outer shell 20.

It should be recognized through all of the descriptions and illustrated Figures that the items on the backplate 300 may be reversed, such as mirror-image of each other. More specifically, while viewing the front of the backplate 300, the electric box 334 is illustrated as being on the right side and the air channel 350 is illustrated on the left. These items may be reversed as a mirror-image of each other with the electric box 334 on the left and the air channel 350 on the right. Of course, the lower portion 304, similar to the middle portion 306 and upper portion 308, includes a variety of attachment locators 322 which are discussed in more detail below. The lower portion 304 may also include filter brackets 440 to receive an optional filter 442. To minimize the number of different parts and assembly, it is expected that the filter brackets 440 will be present on backplates 300 such that the end user can add a filter 442 whenever desired.

The backplate 300 may be viewed as having two opposing surfaces, specifically a first surface 314 and a second surface or wall surface 310. The first surface 314 includes the filter brackets 440, electric box 340, and the raised air channel 350. Of course, as illustrated in Figures, the second surface or wall surface 310 actually defines the passage through which the air passes in the air channel 350. Therefore, the first surface defines the outer walls of the air channel 350 as well as the blower inlet 362 and air outlet opening 388.

The lower portion 304 also includes a blower mount area 450 which is recessed relative to a substantially planar portion 316 of the backplate 300. The blower mount area 450 includes attachment areas 458 to which the illustrated blower mounts 124 on the housing 122 of the blower assembly 120 attach. This allows the blower assembly 120 to be securely fastened to the backplate 300. Given the illustrated round nature of the blower assembly 120, as illustrated in FIG. 2, the blower mount area 450 may include a recessed area 452 to place the housing 122 of the blower assembly 120 as close to the supporting structure 12 as possible. As illustrated in FIG. 2, the backplate 300 may even include an opening 454 to further mount the blower assembly 120 as close as possible to the supporting structure 12. The opening 454 each allow the housing 122 of the blower assembly 120 to extend beyond the first surface 344, specifically as close as possible to the supporting structure 12, thereby providing as compact of a dryer unit as possible. More specifically, the closer the blower assembly 120 may be mounted to the supporting structure 12, the more compact the underlying assembly, minimizing the distance the outer shell 20, specifically the outer contoured surface 30, protrudes from the wall or supporting structure 12.

The lower portion 304 of the backplate 300 includes a portion of the air channel 350, specifically the air entrance chamber 360. As illustrated in FIG. 2, the walls 364 defining the blower inlet 362 are defined by the first surface 314. The blower inlet 362 as illustrated in FIG. 2 is configured to receive a gasket 430 including a slot 432. The slot 432 is configured to sealingly engage and receive the edges of the wall 364. The gasket 430 is expected to be made out of a compliant material and includes an opening 434 which sealingly engages an outlet on the blower assembly 120. The gasket 430 being formed of a compliant material allows for tolerance differences between the blower assembly 120 and backplate 300 during installation and thereby allows for easy assembly. The gasket 430 being formed out of a compliant material also ensures that vibrations in the blower assembly 120 do not transmit to the backplate 300. The opening 434 on the gasket 430 is illustrated as being axially aligned with the axial rotation of the blower assembly 120. As such, the air exits the end of the blower assembly 120 and is directed into the air entrance chamber 360 substantially perpendicular to the air channel 350 at that point, particularly the longitudinal portion 352 of the air channel 350.

The air channel 350 may be generally broken into two portions, a longitudinal portion 352 extending from the lower portion 304 to the upper portion 308, and a lateral portion 354 extending from the longitudinal portion. The air entrance chamber 360 and air passageway 370 are defined by the longitudinal portion 352 of the air channel 350 and the bulk of the lateral portion 354 substantially defines the air outlet chamber 380.

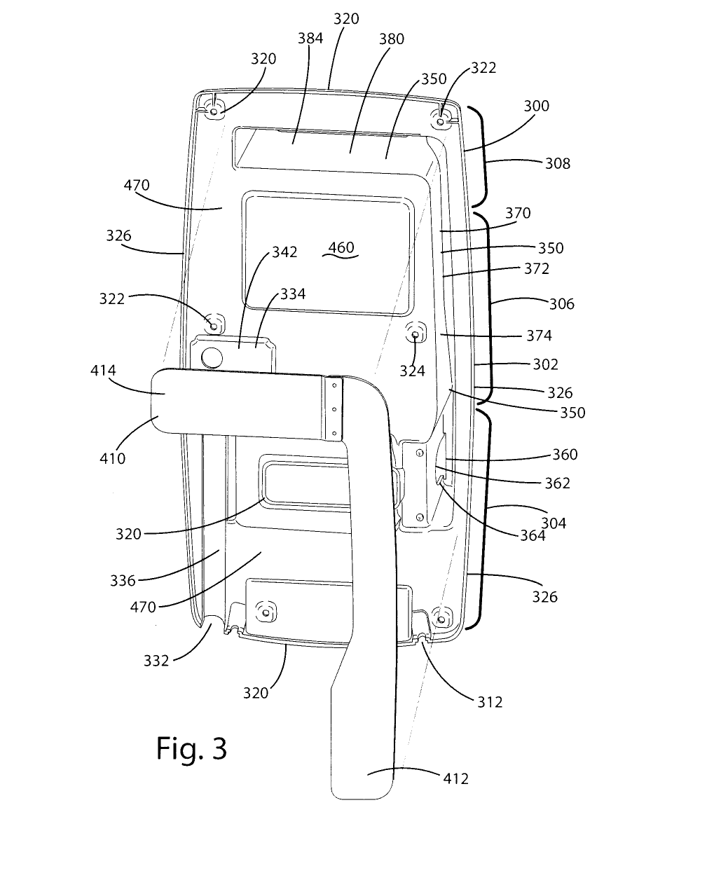

The size, shape, style and configuration of the air entrance chamber 360, air passageway 370, and air outlet chamber 370 may vary, however it has been found that noise of the dryer during operation is reduced if the air entrance chamber 360 has a smaller overall volume than the air outlet chamber 380. The air entrance chamber 360 may also be seen in FIG. 3 and how the cavity formed on the second surface 310 narrows and is reduced in cross-sectional area as it extends through a passage 370 in the middle portion 306 between the air entrance chamber 360 and air outlet chamber 380. As such, the air inlet chamber 360 would have a higher velocity than the air outlet chamber 380.

As illustrated in FIGS. 2 and 3, it may be seen that the backplate 300 is preferably formed as a single member including the contoured air channel 350. While the backplate 300 may be stamped from a metal sheet, it is expected that it will preferably be molded or otherwise formed from a composite material as a single member including the additional items such as the filter brackets 440 and the electrical box 334 to reduce assembly. Any suitable material that will structurally support the blower assembly 120, allow for easy molding of the air channel 350 and not detrimentally increase the sound will be suitable for use as a backplate 300.

The middle portion 306 of the backplate 300 as illustrated in the Figures includes an air passageway 370 extending between the air entrance chamber 360 and the air outlet chamber 380. As the reduction from the air entrance chamber 360 to the air passageway 370 is gradual, either the middle portion 306 may be viewed as including at least a portion of the air entrance chamber 360 or the lower portions 304 including a portion of the air passageway 370.

The middle portion 306 includes on the first surface 314, an electrical box 334 at the termination of the conduit passage 336. Electric box 334 may include a drill plate 342 on the back and walls 340. The walls 340 may extend through the first surface, causing the drill plate 342 to be recessed relative to the first surface, however it could also be aligned with the first surface. The drill plate 342 may also include a pre-drilled hole or wall passage 338. Although not illustrated, a cover may be included to be placed over the box 334. Also not illustrated, the electrical power will extend from the electrical box 334 to the blower assembly 120. The electrical box 334 may be molded as one piece with the backplate 300.

As illustrated in FIG. 3, the bulk of the backplate 300 stands proud of the supporting structure 12 such that at least a quarter inch, preferably one half inch of space, exists between the second surface 310 and the supporting structure 12. This feature is generally accomplished through the use of height locators 320, such as the attachment locators 322 and the outer lip 326. Even the back of the electrical box 334 in some instances could be a height locator 320. The height locators 320 formed by the attachment locators 322 generally include a raised surface 324 on the second surface 310. The height locator 320 formed by a lip edge 328 on the outer lip 326 cooperates with the other height locators 320 along a generally planar surface for mounting the dryer 10 evenly to the supporting structure 12. The height locator 320 set the majority of the second surface 310 spaced from the supporting structurel2. This allows for the dryer assembly 10 to be configured as a replacement dryer for existing dryers in washrooms and as such, for easy installation. More specifically, when the prior dryer being replaced was installed in the washroom, an electrical service 14 such as a direct wire or electric outlet was placed in a particular location on the supporting structure 12, specific to that prior dryer. As the new dryer 10 does not always meet the shape, style, or configuration of the existing dryer much less the identical location of the electrical power entering the dryer 10, the present invention raises the bulk of the backplate from the supporting structure to allow power to be routed from an electrical service 14 to the electrical box 334 even if the electrical service 14 is not aligned directly with the electric box 334. More specifically, by substantial portions of the backplate 300 standing proud of the supporting structure 12, the backplate 300 defines a wall cavity 470 between the supporting structure and the second surface 310. The outer lip 302 bounds the outer limits of any such wall cavity 470 and the wall cavity 470 is interrupted by an height locators 320. As illustrated in FIG. 3, the wall cavity 470 allows easy routing of electrical lines from wide areas on the backplate 300 to the electric box 334. This prevents major renovation work sometimes required in installing new dryers 10 in washrooms. As illustrated in FIG. 3, it may be seen as long as electrical service 14 is not under the blower mount area 450, easy routing of anywhere set within the outer perimeter 302 of electrical lines to the electric box 334 for an electrical service 14 is possible.

The middle portion 306 may also include a wall opening 460 which is configured to allow space for the outer shell 20, specifically for the middle portion 50 to extend as close to the wall as possible, thereby providing a deeper cavity for the user's hands and also minimizing how far the air outlet 56 must extend from the wall to provide sufficient room for the hands to be dried and for a low-profile dryer 10. The air passage 370 is generally configured to fit within the cavity formed sides 52 on the middle portion 50 of the underside of the outer shell 20.

The longitudinal portion 352 of the air channel 350 generally includes both the air entrance chamber 360 and air passageway 370. The lateral portion 354 of the air channel 350 generally includes the air outlet chamber 380. As illustrated in FIG. 2 as well as the other Figures, the lateral portion 354 generally extends substantially perpendicular from the longitudinal portion 352. It should also be noted that the lateral portion 354 forms the air outlet chamber 380 that extends substantially outward from the supporting structure 12 or backplate 300 relative to the other portions of the air channel 350. The air outlet chamber 380 generally includes an upper wall 382, a lower wall 384, a front wall 386. The front wall 386 and lower wall 384 cooperatively define an air outlet opening 388 defined by outlet edges 390. The outlet edges 390 are configured to allow for easy insertion of an air nozzle assembly 400 having an outer perimeter 402 on which grooves 404 are configured to recedingly receive the outlet edges 390. The air nozzle 400 may be formed in a variety of sizes, shapes, and configurations and include individual air outlets 406. The individual air outlets 406 may also be formed in a variety of sizes, shapes, and configurations to provide differing air flow as desired. As such, the air nozzle assembly 400 may be easily installed into the air outlet opening 388 and may also allow for easy design changes or differing air streams by simply changing or customizing the air nozzle assembly 400. For example, washrooms may have different desired air flows than other settings for the dryer. The interchangeable nozzle assembly 400 not only allows for varying air streams for drying of hands, but also may allow different functional nozzles to be installed, such as for the dryer 10 to act as a hair dryer, shoe dryer or glove dryer.

The air outlet chamber 380 is specifically configured to have a decrease in velocity of the air relative to the other portions of the air channel 350, such as through having an increased volume relative to the air passageway 370 and air inlet chamber 360. More specifically, the air outlet chamber 380 is configured to allow for a velocity of air reduction due to the expanded space relative to the air passageway 370. This drop in velocity of the air reduces the noise and as such, provides a quiet dryer 10. Of course, the air outlet chamber 380 may be formed in a variety of sizes, styles and configurations, which partially depend on the shape of the upper portion 40 of the outer shell 20.

As the backplate 300 is expected to be molded with the air channel 350 in place and the air passage cover plate 410 is installed over the channel. Although not illustrated, a gasket seal may also be used to seal the air channel 350 and prevent any air from exiting the air channel 350, other than through the air outlet 388. The air passage cover plate 410 generally includes a first extending leg 412 and a shorter lateral extending leg 414.

During operation, a user would place their hands near the middle portion 50 of the outer shell 20 at which time a sensor would instruct the air dryer to initiate its cycle. Power would be supplied from the electric box 334 to the blower assembly 120 which supplies air to the air channel from the air inlet 38 and if desired, through the optional filter 442. The blower assembly 120 is expected to be a high-speed unit and would force air through the gasket 430 into the air entrance chamber 360. The air is specifically directed against the walls 364 creating a turbulent effect and then is squeezed down through the air passage 370 increasing the velocity of the air. As the air enters the air outlet chamber 380, it expands and reduces the velocity of the air, which reduces the noise level associated with the blower assembly 120 and air being forced through the channel 350. Air then exits through the air nozzle 400 and specifically through the air outlet 56 on the outer cover or shell 20. After a certain amount of time when no hands are sensed, the dryer would cycle down.

1. A dryer assembly for mounting to a support structure having an electrical service, said dryer assembly comprising:
a backplate configured to mount to the support structure, said backplate defining an air channel and having an upper portion, a middle portion and a lower portion and wherein said air channel extends from said lower portion through said middle portion and to said upper portion and wherein lower portion defines a blower inlet in fluid communication with said air channel and said upper portion defines an air outlet in fluid communication with said air channel.

2. The dryer assembly of claim 1 wherein said air channel includes a longitudinal portion and a lateral portion extending therefrom and wherein said lateral portion is located in said upper portion, and defines said air outlet, and wherein said blower inlet is defined by said longitudinal portion.

3. The dryer assembly of claim 1 wherein said backplate includes an outer perimeter having a first longitudinal side approximately aligned with a second longitudinal side and first and second lateral sides extending between said longitudinal sides, and wherein said longitudinal sides are greater in length than said lateral sides and wherein said air channel includes a longitudinal portion aligned with said longitudinal sides and wherein said lateral sides each have a length and wherein said longitudinal portion is located within 25% of said length of said lateral side from said longitudinal side.

4. The dryer assembly of claim 1 wherein said air channel includes a first chamber in said lower portion, a second chamber in said upper portion and an air passageway extending therebetween in said middle portion, and wherein said second chamber has a volume that is greater than the volume of said first chamber.

5. The dryer assembly of claim 4 wherein said air passage has a lateral cross sectional area less than the lateral cross sectional areas of each of said first chamber and said second chambers.

6. The dryer assembly of claim 5 wherein air is fluidly channeled through said air channel from said blower inlet to said air outlet and wherein said air channel is configured to increase the velocity of said air as it moves from said first chamber to said air passage and decrease the velocity of said air as it moves from said air passage to said second chamber.

7. The dryer assembly of claim 6 wherein said air channel is configured to ensure that during operation said first chamber has a higher velocity of air movement than said second chamber under a constant supply of air through said blower inlet.

8. The dryer assembly of claim 1 wherein said air channel includes a first chamber having walls defining said blower inlet configured to sealing receive a gasket having a laterally extending opening in fluid communication with said first chamber and wherein said gasket sealingly engages a blower assembly.

9. The dryer assembly of claim 1 wherein said backplate includes a first surface and a second surface bounded by an outer perimeter and wherein an outer lip extends on said second surface away from said first surface, and wherein said air channel protrudes from said first surface and said second surface defines a first chamber, a second chamber and an air passage of said air channel and wherein said blower inlet and said air outlet each form a passage between said first and second surfaces and wherein said outer lip includes an outer edge having a substantially planar surface configured to mount against the support structure.

10. The dryer assembly of claim 9 wherein said outer lip is interrupted by at least one attachment feature.

11. The dryer assembly of claim 9 wherein said outer lip is interrupted by at least one electrical passage.

12. The dryer assembly of claim 9 further including an outer cover and wherein said outer cover is configured to engage said outer lip for a substantial portion of said outer perimeter.

13. The dryer assembly of claim 9 wherein said backplate further includes a plurality of attachment locators configured to allow attachment of said backplate to the support structure and wherein said attachment locators include a raised surface on said second surface and wherein said raised surface is in substantially planar alignment with said outer edge.

14. The dryer assembly of claim 9 wherein said second surface includes recessed portions relative to said outer edge.

15. The dryer assembly of claim 14 wherein said recessed portions are recessed at least a 10 mm relative to said outer edge.

16. The dryer assembly of claim 14 wherein said recessed portions include portions of the second surface proximate to an electrical box on the first surface.

17. The dryer assembly of claim 14 wherein said recessed portions of said second surface form a wall cavity when mounted on the supporting surface and allow power to be routed from the electrical service to said electrical box without drilling holes between said first and second sides other than within the area defined by the first surface within the walls of said electrical box.

18. The dryer assembly of claim 1 wherein said backplate includes a first surface and a second surface bounded by an outer perimeter and wherein an outer lip extends on said second surface away from said first surface and wherein said second surface defines an electrical passage having a concave surface extending from said outer lip to an area proximate to an electrical box located on said first surface.

19. The dryer assembly of claim 18 wherein said electrical box defines a hole between said first surface and said second surface.

20. The dryer assembly of claim 1 wherein said air outlet is defined by edges and wherein said edges are configured to sealingly receive an air nozzle.

21. The dryer assembly of claim 1 wherein said backplate includes a first large opening forming at least 10% of the area of the backplate in said middle portion, and a second large opening forming at least 5% the area of the backplate in said lower portion.

22. A dryer assembly for mounting to a support structure having an electrical service, said dryer assembly comprising:
a backplate configured to mount to the support structure, said backplate having a first surface and an opposing second surface configured to face the support structure and wherein said backplate defines a blower inlet extending between said first and second surfaces and an air outlet extending between said first and second surface;
an air channel defined by said backplate and extending between said blower inlet and said air outlet; and
a blower assembly in fluid communication with said air channel.

23. The dryer assembly of claim 22 further including a cover plate and wherein said air channel includes a cavity defined by said second surface and said cover plate seals said cavity from said second surface.

24. The dryer assembly of claim 23 wherein said air channel includes an air inlet chamber proximate to said blower inlet and an air outlet chamber proximate to said air outlet and an air passageway extending between said air inlet chamber and said air outlet chamber and wherein said air passageway has a smaller lateral cross sectional area than said lateral cross sectional area of said air inlet chamber and said air outlet chamber.

25. The dryer assembly of claim 22 wherein said backplate includes an integral electric box having walls and a conduit passage extending between said electric box and an edge of said backplate.

26. The dryer assembly of claim 22 wherein said backplate includes attachment features and is bounded by an outer perimeter and wherein an outer lip extends on said second surface away from said first surface, and wherein said air channel protrudes from said first surface and wherein said outer lip includes an outer edge having a substantially planar surface configured to mount against the support structure, and wherein said attachment features include a surface in substantial planar alignment with said planar surface.

27. The dryer assembly of claim 22 wherein said backplate includes a contoured recess on said first surface proximate to said blower assembly.

28. A dryer assembly for mounting to a support structure having an electrical service, said dryer assembly comprising:
a backplate configured to mount to the support structure, said backplate having an outer perimeter bounding a first surface and an opposing second surface and wherein said second surface is configured to face the support structure and wherein said backplate defines a blower inlet extending between said first and second surfaces and an air outlet extending between said first and second surface;
an air channel defined by said backplate and extending between said blower inlet and said air outlet;
a blower assembly in fluid communication with said air channel; and
an electrical box integrally formed on said backplate and an electrical passage formed on said backplate extending between said electrical box and said outer perimeter.

29. The dryer assembly of claim 28 wherein said second surface is configured to be for its majority spaced at least 10 mm from the support structure.
